(19) United States
(12) Patent Application Publication
(10) Pub. No.: US 2025/0296596 A1
(43) Pub. Date: Sep. 25, 2025

(54) ADAPTIVE PERCEPTION MODELS USING SENSOR IMAGING TENSOR

(71) Applicant: QUALCOMM Incorporated, San Diego, CA (US)

(72) Inventors: Varun Ravi Kumar, San Diego, CA (US); Louis Joseph Kerofsky, San Diego, CA (US); Senthil Kumar Yogamani, Headford, Galway (IE)

(21) Appl. No.: 18/610,000

(22) Filed: Mar. 19, 2024

(51) Int. Cl. B60W 60/00; G05B 13/02; G06V 10/72; G06V 20/56

(52) U.S. Cl. CPC B60W 60/001; G05B 13/0265; G06V 10/72; G06V 20/56; B60W 2556/00

(57) ABSTRACT

A method for processing image data and sensor data in an autonomous vehicle includes receiving image data and sensor data generated by one or more sensors of an autonomous vehicle, encoding the sensor data into a multichannel sensor imaging tensor to generate encoded sensor data, providing the image data and the encoded sensor data to an autonomous driving system trained to control the autonomous vehicle, and executing, by the autonomous driving system, one or more operations for controlling the autonomous vehicle based at least in part on the image data and the encoded sensor data.

### TECHNICAL FIELD

This disclosure relates to image processing.

### BACKGROUND

Advancements in artificial intelligence (AI) and deep learning technology are leading to more autonomous vehicles and advanced driving assistance systems (ADAS). Autonomous vehicles and ADAS systems may utilize on-board vehicle sensors and on-board computing resources to identify vehicles and other road agents in their environment and to make driving decisions. Current AI-based perception systems for autonomous driving heavily rely on neural networks like Convolutional Neural Networks (CNNs) and transformers to process sensor data, such as camera and LiDAR inputs. Current approaches have led to advancements in autonomous driving technology, but there are still limitations and challenges to address. The aforementioned networks are often trained on data from specific sensor configurations. Such training may limit generalizability of AI-based perception systems to different sensor setups or environmental conditions. When the sensor hardware changes, even slightly, the entire network may need to be retrained from scratch.

Accordingly, current approaches may be wasteful in terms of time, computer resources, and potentially, the data used for training. For example, a network may need to be retrained every time a new car model is released with a slightly different camera or LiDAR setup. Networks trained on specific sensor setups often struggle to perform well in new environments or with different sensor configurations the networks have not encountered before. This lack of generalizability may lead to unpredictable behavior and potential safety concerns in real-world driving situations.

### SUMMARY

In general, this disclosure describes techniques for efficient adaptive perception models that employ a Sensor Imaging Tensor (SIT). The SIT may essentially inject knowledge about one or more sensors into the learning process. The SIT may essentially be an additional input to the AI-based perception system, alongside the raw sensor data (e.g., camera images, LiDAR point clouds, and the like). Each channel in the SIT may encode a specific parameter related to the sensor's imaging process, such as, but not limited to: exposure and gain. In an aspect, the exposure may measure the amount of light captured by the sensor. Gain may measure amplification of the captured signals. By including pixel-level details about, for example, exposure, gain, focus, dynamic range, and bit depth, the perception system may no longer need to implicitly learn these features from the data. The sensor imaging tensor may make an autonomous driving system more sensor-agnostic and may allow the autonomous driving system to generalize better to different hardware configurations. With sensor information explicitly encoded, the autonomous driving system may not need to be retrained for every new sensor setup. Reduced retraining may save time, computing resources, and data. The autonomous driving system may learn sensor-agnostic features, which may enable the autonomous driving system to perform well on unseen sensor configurations and to adapt to different environments. By understanding how sensor properties influence the data, analysts may gain better insight into the autonomous driving system's decisions and make the system more trustworthy. In one aspect, the explicit sensor information might allow for the development of smaller and more efficient neural networks, further reducing computational costs.

By incorporating sensor metadata, networks may be trained on larger, more diverse datasets encompassing various sensor configurations. Leveraging larger, more diverse data sets may enrich the training data and may allow the autonomous driving system to learn generalizable features, improving framework's performance across different environments and sensor setups. As yet another non-limiting advantage, sensor metadata may provide the autonomous driving system with explicit information about the sensor's characteristics, such as, but not limited to, basic sensor information (e.g., sensor type, manufacturer and model, serial number), measurement characteristics (e.g., units of measurement, measurement range, accuracy and precision), operational information (e.g., calibration date and status, operating temperature and humidity range, power consumption), data acquisition details (e.g., sampling rate, resolution, data format), location information (e.g., geographical coordinates, relative position), and the like.

In one example, a method includes receiving image data and sensor data generated by one or more sensors of an autonomous vehicle; and encoding the sensor data into a multichannel sensor imaging tensor to generate encoded sensor data. The method also includes providing the image data and the encoded sensor data to an autonomous driving system trained to control the autonomous vehicle; and executing, by the autonomous driving system, one or more operations for controlling the autonomous vehicle based at least in part on the image data and the encoded sensor data.

In another example, this disclosure describes an apparatus configured to process image data and sensor data in an autonomous vehicle, the apparatus comprising a memory, and one or more processors implemented in circuitry and in communication with the memory, the one or more processors configured to receive image data and sensor data generated by one or more sensors of an autonomous vehicle, encode the sensor data into a multichannel sensor imaging tensor to generate encoded sensor data, provide the image data and the encoded sensor data to an autonomous driving system trained to control the autonomous vehicle, and execute, by the autonomous driving system, one or more operations for controlling the autonomous vehicle based at least in part on the image data and the encoded sensor data.

In another example, this disclosure describes a non-transitory computer-readable storage medium storing instructions that, when executed, cause one or more processors of a device configured to process image data and sensor data in an autonomous vehicle to receive image data and sensor data generated by one or more sensors of an autonomous vehicle, encode the sensor data into a multichannel sensor imaging tensor to generate encoded sensor data, provide the image data and the encoded sensor data to an autonomous driving system trained to control the autonomous vehicle, and execute, by the autonomous driving system, one or more operations for controlling the autonomous vehicle based at least in part on the image data and the encoded sensor data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 is a diagram illustrating an example AI-based autonomous driving system that may perform the techniques of this disclosure.

FIG. 4 is a flowchart illustrating an example method for providing sensor metadata using sensor imaging tensor in accordance with the techniques of this disclosure.

### DETAILED DESCRIPTION

Currently, neural networks used in autonomous driving systems are often trained on datasets specific to a particular sensor configuration (e.g., camera resolution, LiDAR range). Such training may limit the diversity of data and potentially may hinder the neural network's ability to generalize to different sensor setups. When new sensor hardware emerges, current approaches often require retraining the entire autonomous driving system from scratch. Such retraining may be time-consuming and resource-intensive. In contrast, as contemplated by the disclosed techniques, by incorporating sensor metadata, networks may be trained on larger, more diverse datasets encompassing various sensor configurations. Adapting the autonomous driving system and/or an ADAS system to new sensor hardware without full retraining may significantly reduce the computational cost and may improve adaptability. Integrating sensor metadata may make the decision-making process of an autonomous driving system more transparent and understandable. By analyzing how the autonomous driving system utilizes the sensor metadata to adapt generated predictions, analysts may gain insights into the decision-making of an autonomous driving system and may potentially identify potential biases or errors. Enhanced interpretability and explainability may enhance trust and may facilitate debugging and improvement of the system.

In an aspect, sensor metadata may be automatically generated or readily extracted from the sensor itself, reducing the need for manual annotation of raw data. Efficient data collection and annotation may simplify and streamline the data collection and annotation process, lowering the cost and time associated with training large datasets. By explicitly encoding sensor metadata like exposure, gain, and lens properties, the autonomous driving system may no longer be dependent on extracting these features from the data itself. Such explicit encoding may reduce the influence of variations in sensor setup on the output of the autonomous driving system, allowing the autonomous driving system to generalize better to different hardware configurations and environmental conditions. For example, two cameras may be capturing the same scene, but with different levels of brightness. With a SIT containing encoded sensor metadata, the autonomous driving system would not need to adjust interpretation based on the varying brightness level, ultimately producing a more consistent and accurate output. Traditionally, large datasets specific to each sensor configuration are required for training, making the process time-consuming and resource-intensive. The autonomous driving system may allow for training on more diverse datasets encompassing various sensor types and settings.

The encoded information (SIT) may compensate for sensor differences, allowing autonomous driving systems to learn generalizable features from a broader range of data. Such encoding may lead to improved performance with potentially smaller or less specific datasets, enhancing data efficiency. With reduced dependence on specific sensor setups, AI systems equipped with the SIT may be deployed more easily across different platforms and hardware configurations. The use of a SIT may allow a neural network of an autonomous driving system to adapt to varying sensor characteristics without retraining, which may facilitate broader applications, making AI perception systems more versatile and scalable. The SIT may go beyond simply informing the autonomous driving system about sensor properties. The SIT may potentially assist the autonomous driving system to learn more physically-aware and interpretable features. Furthermore, by understanding the limitations and biases inherent in specific sensor types, the autonomous driving system may be configured to make better decisions. The encoding techniques described herein may also be used in autonomous robots, Virtual Reality (VR) and Augmented Reality (AR) scenarios, where a robot or a wearable headset tracks its own location, and is able to recognize the objects that it encounters.

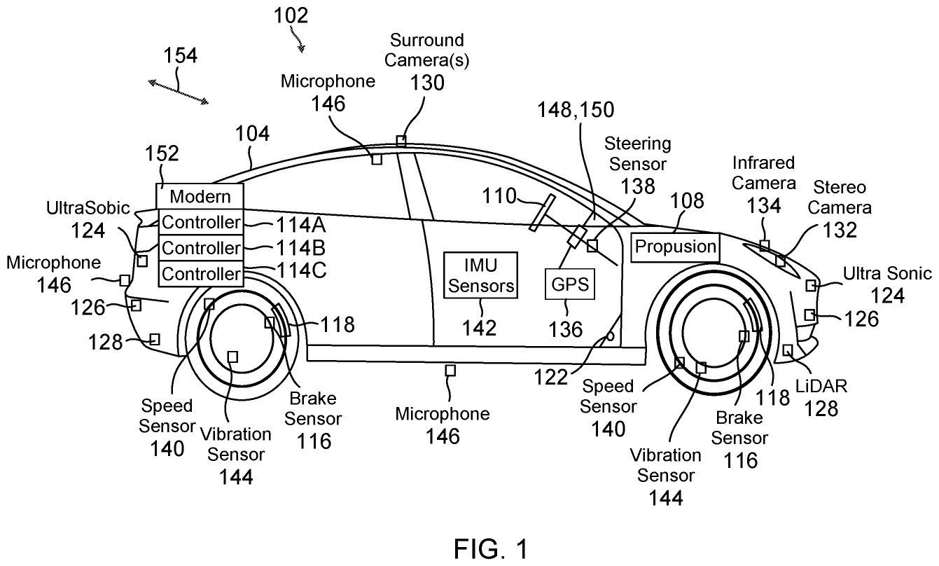

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114 (D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)-a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

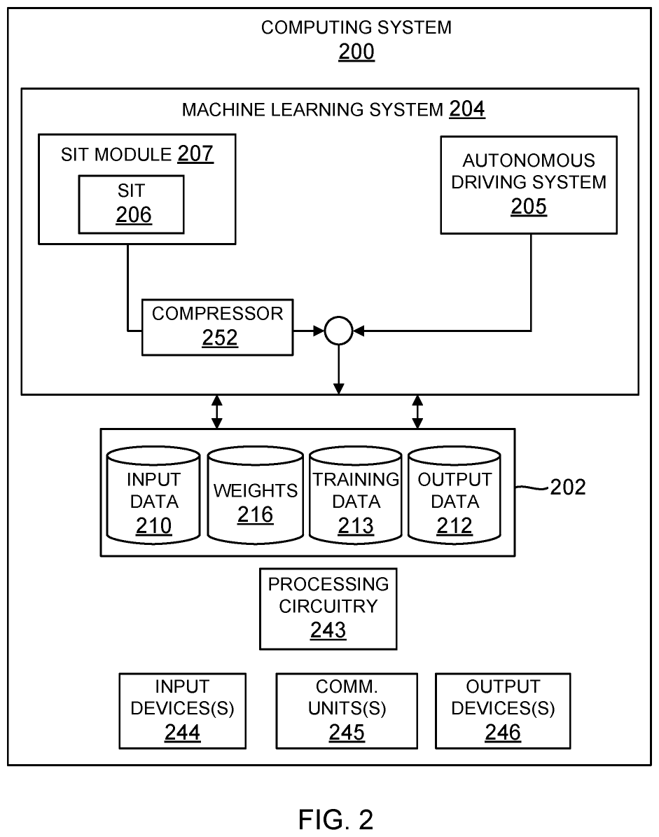

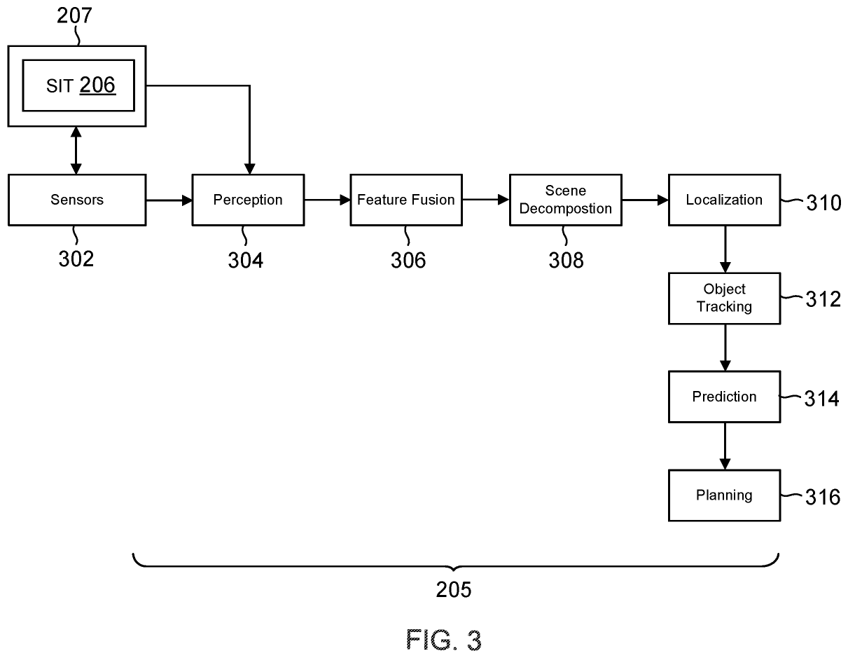

In an aspect, a controller 114 may receive image data and sensor data generated by one or more sensors 128-134 of the vehicle 102. At least one of the images may include a LiDAR image obtained from LiDAR sensor(s) 128. At least one other image may include a multi-camera input image obtained from one or more cameras 130-134. Sensor metadata may include a plurality of characteristics of the one or more sensors 128-134. Next, controller 114 may encode the sensor data into a multichannel sensor imaging tensor (SIT 206 shown in FIGS. 2 and 3). Controller 114 may then provide the received image data and the encoded sensor data to an autonomous driving system 205 (shown in FIGS. 2 and 3) trained to control the vehicle 102. In addition, controller 114 may execute one or more operations for controlling the vehicle 102 based at least in part on the image data and the encoded sensor data (SIT 206).

FIG. 2 is a block diagram illustrating an example computing system 200. As shown, computing system 200 comprises processing circuitry 243 and memory 202 for executing a machine learning system 204, which may represent an example instance of any controller 114 described in this disclosure, such as controller 114 of FIG. 1. In an aspect, machine learning system 204 may include, but is not limited to autonomous driving system 205, SIT module 207 and compressor 252. Autonomous driving system 205 may comprise various types of neural networks, such as, but not limited to, recursive neural networks (RNNs), convolutional neural networks (CNNs), and deep neural networks (DNNs).

Computing system 200 may also be implemented as any suitable external computing system accessible by controller 114, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., SIT module 207), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, SIT module 207 may be configured to encode the sensor data into SIT 206, as described herein. SIT module 207 may receive input data 210 and may generate output data 212. Processed output data 212 generated by SIT module 207 may be used as input data for a perception component (shown in FIG. 3) of the autonomous driving system 205. Input data 210 and output data 212 may contain various types of information. For example, input data 210 may include, but is not limited to, image data, video data, and so on. Output data 212 may include sensor metadata, SIT channels, and so on.

Machine learning system 204 may comprise a pre-trained model that is trained using training data 213 and one or more pre-trained SIT modules 207, in accordance with techniques described herein. In an aspect, SIT 206 may comprise a data structure (e.g., a multi-dimensional array) that combines the actual image data with additional channels containing metadata about the image acquisition process. Instead of including metadata in separate files or annotations, key imaging parameters may be encoded as individual channels within the tensor itself. Encoded key imaging parameters may allow for direct integration with the image data and may simplify the architecture of the autonomous driving system 205. At least some of the following potential parameters may be encoded as channels. Spatial or temporal resolution may be useful for tasks like depth perception, motion analysis, or image registration. Sensor sensitivity and gain may impact the brightness and contrast of the image, and incorporating these parameters as channels could help the autonomous driving system 205 adapt to varying imaging conditions. Understanding the noise profile of the image sensor may be important for tasks like denoising and image restoration. Accordingly, a dedicated channel may encode sensor's noise characteristics information. Distortions introduced by the camera lens may need to be corrected for accurate measurements and recognition. Encoding lens distortion and calibration parameters within the tensor may streamline the correction process. It should be noted that the specific parameters chosen to encode may depend on the specific application and the type of sensor(s) being used.

In an aspect, the general idea of using SIT module 207 by machine learning system 204 may offer several advantages. Combining all information in a single tensor may eliminate the need for separate metadata files or complex data handling pipelines. Autonomous driving system 205 may directly access both image data and relevant metadata during training and inference, potentially improving performance and reducing computational overhead. Encoding sensor information may allow autonomous driving system 205 to learn about the acquisition process and adapt to different sensors and imaging conditions, leading to more robust and generalizable models.

Encoding exposure time E (x, y) directly as Tₑₓₚ (x, y) into SIT 206 may allow autonomous driving system 205 to learn how varying exposure times affect the brightness and contrast of the image. Encoding of the exposure time may be especially beneficial for tasks like High Dynamic Range (HDR) imaging or low-light image enhancement. Autonomous driving system 205 may utilize this information to adjust its predictions accordingly, compensating for overexposed or underexposed pixels and potentially improving its overall accuracy.

Similarly, encoding ISO gain S (x, y) at pixel (x,y) as Tᵢₛₒ (x, y) into SIT 206 may provide the autonomous driving system 205 with information about the sensor's sensitivity to light. ISO/Gain may be important for tasks like noise reduction, as higher ISO/gain settings often introduce more noise into the image. By knowing the per-pixel gain levels, autonomous driving system 205 may better differentiate between noise and actual image features, leading to more effective noise suppression algorithms. Encoding lens aperture A (x, y) as Tₐₚₑᵣ (x, y) into SIT 206 may offer autonomous driving system 205 insights into the depth of field and blur characteristics of the image. Lens aperture information may be valuable for tasks like object segmentation, depth estimation, and bokeh simulation. Understanding the per-pixel aperture information may allow autonomous driving system 205 to account for lens distortions and adjust its predictions accordingly, leading to more accurate object boundaries and depth measurements.

The focal length (F) is usually constant across the image. Encoding the focal length as T_{focal} (x, y)=F may provide valuable information about the field of view captured by the sensor. Autonomous driving system 205 may utilize the focal length knowledge for tasks like perspective correction, 3D reconstruction, and estimating object distances based on their size within the image. Encoding the focus distance at each pixel Df (x, y) as T_{focus} (x, y) into SIT 206 may offer autonomous driving system 205 insights into the blur distribution over the image. Focus distance information may be important for tasks like depth estimation, image deblurring, and identifying in-focus regions for object recognition. By knowing the per-pixel focus distance, autonomous driving system 205 may refine its predictions and potentially achieve better accuracy in these tasks. Encoding the pixel width Px and height Py as separate channels Tₚᵢₓₑₗₓ (x, y)=Px and T_{pixely} (x, y)=Py may provide details about the sensor's resolution and the scale of captured information. Pixel size information may be beneficial for tasks like image scaling, geometric transformations, and understanding the level of detail present in the image. Autonomous driving system 205 may leverage pixel size information to adjust its processing accordingly and potentially improve its performance in tasks that require spatial accuracy. Encoding bit depth B as T_{depth} (x, y) may provide autonomous driving system 205 with information about the dynamic range of the captured data. Bit depth may indicate how many grayscale values each pixel can take, ranging from 2B for a single bit to 28B for a typical 8-bit sensor. Autonomous driving system 205 may leverage this information in tasks like image quantization, histogram equalization, and HDR imaging. Knowing the available range of bit depth values may allow autonomous driving system 205 to better represent brightness information, leading to more accurate predictions and potentially improved noise reduction or contrast enhancement.

The disclosed SIT 206, e.g., tensor T may include a plurality of channels, such as, but not limited to, Tₐₚₑᵣ, T_{focal}, T_{focus}, Tₚᵢₓₑₗₓ, T_{pixely}, and T_{depth}, which may present a rich source of information for neural network. The comprehensive encoding discussed herein may unlock numerous possibilities for various image processing tasks. Autonomous driving system 205 may adapt its algorithms based on the sensor's capabilities and imaging conditions. For example, knowing the bit depth and pixel size could influence how autonomous driving system 205 performs noise reduction for high-resolution or low-dynamic-range images. Combining data from multiple sensors with SIT 206 may enable even more sophisticated image processing. Understanding the individual sensor characteristics like focal length, bit depth, and pixel size allows autonomous driving system 205 to better integrate and interpret the complementary information, leading to more accurate predictions and richer data representations. By using the enriched data structure of SIT 206, autonomous driving system 205 may learn how different parameters interact and affect the image formation process without the need for explicitly labeled training data. Unsupervised learning may open up possibilities for self-supervised learning and domain adaptation, where autonomous driving system 205 may learn from unlabeled images and generalize its knowledge to different imaging scenarios.

As sensor metadata becomes more comprehensive, SIT 206 may grow significantly, increasing computational and storage costs. In an aspect, to address the aforementioned problem, machine learning system 204 may use compressor 252 to compress SIT 206 while preserving information for effective sensor-aware processing. In an aspect, compressor 252 may use, for example, Principal Component Analysis (PCA) or autoencoder to perform the compression.

In an aspect, compressor 252 may find a lower-dimensional representation that captures the main variance in the data. In an aspect, compressor 252 may reshape the SIT 206 into a matrix X where each row is a pixel vector.

In an aspect, compressor 252 may compute the covariance matrix C. In an aspect, compressor 252 may perform eigen-decomposition of C to obtain principal components V and eigenvalues A. In an aspect, compressor 252 may select the top k principal components Vk with the largest eigenvalues.

In an aspect, compressor 252 may project each pixel vector xi onto Vk to obtain a compressed representation X_{pca}. Compressor 252 may reshape X_{pca} back into a tensor T_{pca} with k channels.

In an aspect, compressor 252 may be implemented as autoencoder. Compressor 252 implemented as autoencoder may learn a compressed representation using a neural network architecture. Accordingly, compressor 252 may comprise a trained autoencoder with an encoder that compresses SIT 206 and a decoder that attempts to reconstruct the original SIT 206. For example, the compressed representation may be the output of the encoder. Smaller SIT 206 may require less memory, facilitating storage and transmission. Smaller tensors may be processed faster, reducing computational costs. Compression may remove redundant or noisy information, potentially enhancing performance.

In other words, compression inevitably involves information loss. The challenge is to find representations that retain the most relevant information for the task at hand. In an aspect, autonomous driving system 205 may need adjustments to effectively utilize compressed SIT representations. Compression and decompression may add computational overhead, which should be considered in real-time applications.

Autoencoder may learn a compressed representation of the SIT 206 using a neural network that captures sensor information while reducing dimensionality.

In an aspect, encoder (E) may take the SIT T as input. In an aspect, the encoder may compress T into a lower-dimensional latent vector z: z=E_θ(T). Decoder (D) may attempt to reconstruct the original SIT T from the latent vector z: T_recon=D_φ(z). The training objective for an autoencoder is to minimize the reconstruction loss between the original SIT and the reconstructed SIT: L (θ, φ)=∥T-T_{recon}∥². After training, the latent vector z produced by the encoder may serve as the compressed representation of the SIT 206.

In an aspect, the autoencoder may learn compression strategies directly from data, potentially adapting to complex patterns and relationships in sensor metadata. For example, the autoencoder may capture non-linear relationships that might be missed by linear methods like PCA. The autoencoders may be tailored to learn representations that are particularly relevant for specific image processing tasks. However, training autoencoders may be computationally expensive. The autoencoders may overfit to training data, potentially hindering generalization to unseen data. More specifically, the learned latent representation may be less interpretable than PCA's principal components.

FIG. 3 is a diagram illustrating an example AI-based autonomous driving system 205 that may perform the techniques of this disclosure. FIG. 3 is provided for purposes of explanation and should not be considered limiting of the techniques as broadly exemplified and described in this disclosure. For purposes of explanation, this disclosure describes framework 300 illustrated in FIG. 3 that may be configured to leverage embeddings provided by SIT 206.

In an aspect, a plurality of sensors 302 may gather raw data about the environment, such as images, depth maps, LiDAR point clouds, radar readings, audio signals, and the like. The plurality of sensors 302 may include, for example, but not limited to at least one of sensors illustrated in FIG. 1: one or more ultrasonic sensors 124, one or more RADAR sensors 126, one or more LiDAR sensors 128, one or more surround cameras 130, one or more stereo cameras 132, one or more infrared cameras 134. In an aspect, as described above, SIT 206 may capture and encode sensor-specific characteristics (such as, but not limited to, exposure, focus, lens distortion, response function, field of view) needed for accurate data interpretation. For example, SIT 206 may provide geometric information (e.g., sensor positions, orientations) for spatial understanding. Perception module 304 may receive output generated by the SIT module 207 and may be configured to identify and extract meaningful features from sensor data (e.g., edges, corners, textures, objects). In an aspect, the feature fusion module 306 may combine features from multiple sensors for comprehensive understanding (e.g., fusing visual features with depth information for 3D scene reconstruction).

In an aspect, the scene decomposition module 308 may partition the scene into meaningful regions or objects (e.g., identifying road, obstacles, pedestrians). For example, the scene decomposition module 308 may assign labels to detected objects or regions (e.g., recognizing cars, bikes, traffic signs). The localization module 310 may determine the system's position and orientation within the environment (e.g., using GPS, visual odometry, Simultaneous Localization and Mapping (SLAM), and the like). More specifically, in an aspect, the localization module 310 may track positions of objects relative to the system (e.g., tracking moving vehicles or pedestrians). In an aspect, the object tracking module 312 may track objects over time, even under occlusions or appearance changes (e.g., using Kalman filters, particle filters, and the like). The object tracking module 312 may also estimate future object trajectories based on observed motion patterns.

The prediction module 314 may predict how the environment and objects might evolve over time (e.g., predicting pedestrian paths, vehicle trajectories).

In an aspect, the prediction module 314 may account for potential errors and uncertainties in predictions.

In an aspect, the planning module 316 may determine optimal actions based on current understanding and predictions to achieve goals (e.g., planning paths for autonomous vehicles, generating robot control commands). In an aspect, the planning module 316 may respect physical limitations, safety requirements, and task objectives. The planning module 316 may replan dynamically as the environment or goals evolve. Real-time processing of large sensor datasets may pose computational challenges. Handling uncertainty in sensor measurements and model predictions is important for reliable decision-making by the planning module 316.

Having pixel-level information for each parameter may provide autonomous driving system 205 with a richer understanding of the image acquisition process, enabling it to adapt framework's processing accordingly and potentially achieve better performance. Overall, explicitly encoding these metadata parameters as separate channels in SIT 206 may empower autonomous driving system 205 with an in-depth understanding of the image formation process The autonomous driving system 205 may adjust one or more algorithms based on the specific imaging conditions captured by sensors 302. By accounting for sensor characteristics, autonomous driving system 205 may potentially achieve better performance on various image processing tasks, even in challenging scenarios with varying lighting, focus, or resolution. Combining data from multiple sensors 302 with their individual SITs 206 may allow for even more comprehensive analysis and interpretation of the scene, for example, by scene decomposition module 308.

Unlike relying on separate files or annotations, encoding the aforementioned properties as channels within the image data itself may simplify the pipeline illustrated in FIG. 3 and may allow for direct integration with the image data. Direct integration may lead to improved efficiency and reduced computational overhead.

In an aspect, by providing pixel-level information for each parameter, autonomous driving system 205 may have access to a richer representation of the image formation process. Richer information may include, but is not limited to, understanding how factors like aperture, focal length, focus, pixel size, and bit depth affect the captured data. SIT 206 may enable the autonomous driving system 205 to adapt framework's processing based on the specific imaging conditions. For example, perception module 304 may adjust its deblurring algorithm based on the focus distance or may choose different quantization methods based on the bit depth. Generally, autonomous driving system 205 may learn to leverage the aforementioned metadata channels during the training process. For example, autonomous driving system 205 may discover how different parameters influence the image data and may utilize that knowledge to improve network's predictions performed by prediction module 314. The disclosed techniques may even open doors for unsupervised learning. With access to the enriched data structure, various modules 304-316 of autonomous driving system 205 may be able to learn about the image acquisition process and may adapt their corresponding processing without the need for explicitly labeled training data. In an aspect, explicitly encoding imaging properties as extra input provides the autonomous driving system 205 with a powerful tool for understanding and processing images.

In an aspect, instead of having separate channels for each parameter, a single Camera Response Function (CRF channel) may encode the combined effect of several parameters on pixel values. Such encoded CRFs may reduce the dimensionality of the SIT 206 and may potentially improve computational efficiency for autonomous driving system 205. CRFs may capture the non-linear relationship between imaging parameters and pixel intensity, providing a more compact and expressive representation than individual channels. By learning a single CRF, autonomous driving system 205 may generalize better to unseen combinations of imaging parameters. Improved generalizability may be especially beneficial for real-world scenarios where camera settings might vary widely. The parametric curve fitting may allow for capturing the aspects of the CRF while ignoring noise and subtle variations, leading to a more robust model. Accurately modeling the CRF may be challenging, especially for complex cameras or non-ideal imaging conditions. The choice of parametric curve may play an important role in capturing the key characteristics of the response function. In an aspect, training neural network to effectively utilize the CRF channel may require different training strategies compared to using individual parameter channels.

Although compressed, the encoding may still retain information about the CRF for each pixel. Preserving key information may allow the autonomous driving system 205 to understand how different imaging parameters (exposure, ISO, etc.) affect the captured values at a localized level. By encoding per-pixel parameters, the autonomous driving system 205 may adapt to variations in lighting, lens properties, and other factors that might influence the CRF across the image. Selecting an appropriate compression technique may be important for preserving the key information in the CRFs while minimizing redundancy and maintaining efficiency. Different compression algorithms may be suitable depending on the sensor/camera type and the desired level of accuracy. When compressing per-pixel parameters, machine learning system 204 may need to ensure that the resulting encoding retains the spatial relationships and smoothness of the image data. Techniques like spatial filtering or incorporating neighboring pixel information may help address this challenge. The network architecture and training strategies might need adjustments to effectively utilize the compressed CRF information. Interpreting the network's predictions based on the encoded parameters may also require new methods and visualization techniques.

In an aspect, the CRF may model the complex relationship between the incoming light that hits the sensor, such as, for example, LiDAR 128 and the final pixel values recorded in the image. Relationship between light and pixel values may allow understanding how different imaging parameters affect the captured data. Several parameters may influence the CRF, including, but not limited to, exposure time (E), ISO/gain(S), aperture (A). For example, longer exposure may allow more light to accumulate, resulting in brighter pixel values. Higher ISO settings may amplify the signal coming from the sensor, leading to brighter images but also introducing noise. Wider apertures may allow more light to enter the camera, contributing to brighter pixels, while narrower apertures may create shallower depth of field.

In an aspect, the following equation (1) accurately captures the CRF as a function f that takes the three parameters as inputs and outputs the corresponding pixel value p:

p=f(E,S,A) (1)

The CRF function may be modeled in various ways, including, but not limited to, parametric curves, non-linear regression models, or even deep learning approaches. Knowing how different parameters affect the captured data allows machine learning system 204 to correct for distortions or biases introduced by the camera and sensor. By modeling the CRF for different exposures, machine learning system 204 may combine multiple images to create HDR images with extended dynamic range and improved tonal detail. Approximating the CRF function with a parametric curve like αE^{β}+γS^{δ}+εA^{ξ}+η is a highly efficient and effective approach for encoding sensor information in the SIT 206. Instead of dedicating individual channels to each parameter (E, S, A), this technique uses a single channel containing the fitted parameters (α, β, γ, δ, ε, ξ, η). Such encoding may significantly reduce the dimensionality of the SIT 206. Smaller data size may be beneficial for memory-constrained devices or when dealing with large datasets. Reduced complexity may translate to improved computational efficiency, leading to faster training and inference times. In an aspect, the parametric curve may capture the essence of the CRF relationship between several parameters in a single expression.

In an aspect, machine learning system 204 may remove redundant information, allowing for efficient storage and transmission of the CRF characteristics. The fitted parameters may potentially generalize well to unseen combinations of imaging settings, enabling the autonomous driving system 205 to adapt to diverse image acquisition conditions. Determining the optimal values for the parameters (α, β, γ, δ, ε, ξ, η) may require fitting the parametric equation to training data.

In yet another aspect, fitting process may involve capturing images under various controlled lighting conditions and camera settings (E, S, A). The fitting process may also involve recording the corresponding pixel values for each image. In addition, the fitting process may involve applying optimization algorithms to find the parameter values that best minimize the difference between the predicted pixel values from the curve and the actual pixel values in the training data. Selecting an appropriate parametric function may be important for accurately capturing the non-linearities and complexities of the actual CRF. Different curves might be suitable depending on the camera/sensor type and desired level of accuracy.

Each fitted parameter may be assigned a unique channel within the SIT 206, resulting in seven new channels. Tₐₗₚₕₐ (x, y) may encode the scaling parameter a for the exposure term. T_{beta} (x, y) may encode the exponent β for the exposure term. T_{gamma} (x, y) may encode the scaling parameter γ for the ISO/gain term. T_{delta} (x, y) may encode the exponent δ for the ISO/gain term. Tₑₚₛᵢₗₒₙ (x, y) may encode the scaling parameter ε for the aperture term. T_{zeta} (x, y) may encode the exponent ξ for the aperture term. Tₑₜₐ (x, y) may encode the offset n. Each channel may store pixel-level values for the corresponding parameter. In other words, each pixel in these channels may represent the estimated CRF parameter for that specific pixel location in the image. By encoding the parameters at the pixel level, the SIT 206 may retain spatial relationships within the image, allowing the modules 304-316 to adapt their corresponding processing based on local variations in the CRF.

In an aspect, the autonomous driving system 205 may learn to infer relationships between image content and sensor metadata, potentially leading to improved performance in tasks like image reconstruction, denoising, and enhancement, which may be performed by perception module 304, for example. While the aforementioned techniques provide granular information, further compression techniques may be explored to reduce the number of channels if storage or computational efficiency is a primary concern. Understanding how the autonomous driving system 205 leverages these channels for decision-making may require new visualization and analysis techniques.

By incorporating the seven channels for fitted CRF parameters into the SIT 206, the autonomous driving system 205 may receive sensor information in a compact and efficient manner. These techniques may use fewer channels than individually encoding E, S and A, reducing dimensionality and potential computational overhead. During inference, planning module 316 may access and utilize these channels to make inferences about the sensor settings that were used to capture the image. The disclosed techniques may effectively leverage the CRF to capture sensor metadata in a compact way.

Instead of explicitly encoding individual parameters, the fitted curve may compactly represent the key relationships between exposure, ISO, and aperture, preserving information while reducing redundancy. Combining data from multiple sensors 302 with their SITs 206 may allow for even more comprehensive analysis and interpretation of multi-sensor image data. The architecture of the autonomous driving system 205 and training strategies may need adjustments to effectively utilize the encoded CRF information. Understanding how the autonomous driving system 205 leverages these channels for decision-making may require new visualization and analysis techniques. In an aspect, while this encoding is more compact than individual parameter channels, further compression techniques could be explored if storage or computational efficiency is paramount.

In an aspect, the term “lens distortions”, as used herein refers to optical aberrations that may cause straight lines in real-world scenes to appear curved or warped in captured images. Common distortions may include but are not limited to, barrel distortion and pincushion distortion. For example, barrel distortion may include outward bulging of image edges, resembling a barrel. Pincushion distortion may include inward pinching of image edges, resembling a pincushion.

A distortion function mathematically models the relationship between distorted (observed) pixel coordinates and their corresponding undistorted (true) coordinates: p_{d}=d(pᵤ). In an aspect, instead of explicitly encoding distortion parameters, separate channels may be created within the SIT 206 that store distortion maps. Distortion maps are images where each pixel value represents the estimated displacement caused by distortion at that pixel location. Distortion maps may be generated using calibration techniques or approximated using parametric models of common distortion types.

During training and inference, the perception module 304 may access the aforementioned distortion maps to understand the spatial warping present in the image. In an aspect, explicit information may provide the perception module 304 with explicit knowledge of image distortions, reducing the need to learn such image distortions implicitly. Encoding of spatial distortions may lead to faster convergence during training. Encoding of spatial distortions may further lead to improved accuracy and robustness in tasks affected by distortions (e.g., object detection which may performed by object tracking module 312, depth estimation which may be performed by feature fusion module 306, for example). The feature fusion module 306 may adapt its processing to account for distortions, potentially improving performance in tasks like, but not limited to, feature extraction, image alignment, geometric reconstruction. The effectiveness of the disclosed techniques may depend on the accuracy of the distortion maps. Distortion patterns may vary across different lenses and camera settings, potentially requiring multiple distortion maps or adaptive models.

In an aspect, a radial distortion model is a common model frequently used to approximate the distortion function d( ) in lens distortion scenarios. Key components of the radial distortion model include pᵤ (undistorted pixel coordinate), r (radial distance from the image center to pᵤ), k1, k2, and k3 (distortion coefficients that control the severity of the distortion).

In an aspect, radial distortion may be calculated using the following formula (2):

d(pᵤ)=pᵤ(1+k1r²+k2r⁴+k3r⁶) (2).

In an aspect, instead of using distortion maps, the disclosed techniques may encode the distortion coefficients k1, k2, k3 into three separate channels within the SIT 206. Advantageously, the disclosed techniques achieve a compact representation of the distortion model using only three channels, reducing dimensionality and potential computational overhead. During inference, the autonomous driving system 205 may access these channels to retrieve the distortion coefficients.

In an aspect, perception module 304 may then apply the radial distortion model in reverse to “unwarp” the image, mitigating the effects of barrel or pincushion distortion. The unwrapping process may involve calculating pᵤ from p_{d} using the provided model and coefficients. The disclosed techniques compactly represent the distortion model, reducing storage and computational requirements compared to distortion maps.

In an aspect, the disclosed techniques provide the autonomous driving system 205 with explicit knowledge of the distortion characteristics, potentially leading to faster convergence and improved accuracy in tasks affected by distortion. The disclosed techniques enable various modules 304-316 of the autonomous driving system 205 to adapt their corresponding processing to account for distortions, potentially improving performance in various image-related tasks. In one implementation, the effectiveness of the disclosed techniques may depend on the accuracy of the radial distortion model in capturing the actual distortion patterns of the lens. Modules 304-316 may need architectural or training adjustments to effectively utilize the encoded distortion coefficients. Distortion patterns may vary across different lenses and camera settings, potentially requiring multiple distortion models or adaptive strategies.

In another implementation, the concept of encoding distortion parameters or maps into SIT channels may not be limited to the radial distortion model. Encoding of distortion parameters may be applied to various camera distortion models, ensuring flexibility and adaptability in different imaging scenarios. The Unified Camera Model (UCM) may account for both radial and tangential distortions using a set of coefficients. These coefficients may be encoded into SIT channels, providing a more comprehensive representation of lens distortions. The Enhanced Unified Camera Model (EUCM) may extend the UCM by incorporating additional distortion terms to model more complex distortion patterns. The additional coefficients may also be encoded into SIT channels. The double sphere model may represent radial distortion using two spheres with different radii. The parameters of the spheres may be encoded into SIT channels, providing a compact and accurate representation of radial distortion.

Advantageously, providing the autonomous driving system 205 with explicit distortion information through SIT channels may offer several benefits.

In an aspect, explicit encoding may lead to enhanced interpretability of autonomous driving system's 205 decisions, as the encoded parameters may provide insights into how the autonomous driving system 205 is accounting for distortions. Distortion patterns may vary across different lenses and camera settings, potentially requiring multiple distortion models or adaptive strategies.

In an aspect, in video capture, camera settings like exposure, focus, and lens parameters may change automatically on a frame-by-frame basis to adapt to varying lighting conditions, scene content, or user input. To ensure the autonomous driving system 205 always has access to the most up-to-date sensor information, SIT 206 may be dynamically updated for each frame. Such dynamic updates may align the framework's understanding of image formation with the actual conditions under which each frame was captured. SIT 206 for each frame may be denoted as Tₜ, where t represents the frame's timestamp.

The relationship between the raw input image Iₜ and the corresponding SIT Tₜ may be modeled by the function f( ) This function f( ) may encapsulate the process of extracting or estimating sensor metadata and encoding it into SIT channels. The function f( ) may be able to accurately estimate sensor metadata from the raw image data while also being computationally efficient to enable real-time updates. It should be noted that SIT 206 may be capable of handling varying camera models, sensor types, and acquisition conditions. In practice, if the camera system provides direct access to sensor metadata, the function f( ) may simply extract and organize this information into the SIT format. For specific sensor properties like the aforementioned CRF, parametric models may be fitted to training data and may be used to estimate parameters for each frame.

In addition, the machine learning system 204 may provide deep neural networks that may be trained to directly estimate sensor metadata from raw image data, potentially capturing more complex relationships but requiring careful training and computational resources. By providing the autonomous driving system 205 with accurate and up-to-date sensor information, dynamic updates may enhance performance and robustness in various video processing tasks, such as, but not limited to, video-denoising (performed by perception module 304), super-resolution (performed by perception module 304), object tracking (performed by object tracking module 312), video segmentation (performed by perception module 304), and the like. Furthermore, the autonomous driving system 205 may adjust one or more algorithms based on the changing sensor characteristics, leading to more tailored and effective results. In an aspect, estimating sensor metadata from raw images may be computationally demanding, potentially impacting real-time processing. Efficient algorithms and hardware acceleration are important. Balancing speed and accuracy in the estimation process is important for practical applications. For example, some of modules 304-316 may need architectural or training adjustments to effectively utilize dynamically changing SIT information.

Furthermore, function f( ) may analyze raw images. It should be noted that function f( ) may take a raw input image It at time t as input. The function f( ) may extract or estimate relevant sensor metadata from the image content.

Once the machine learning system 204 has the relevant sensor metadata, the machine learning system 204 may organize the estimated metadata into appropriate channels within the SIT Tₜ.

Function f( ) may analyze image brightness to estimate the exposure Et used for capturing the frame. In an aspect, such analysis may involve analyzing pixel intensity distributions and potentially considering noise patterns. The machine learning system 204 implementing function f( ) may also analyze image sharpness to estimate the focus distance Dft. Such analysis may involve examining edges, gradients, or frequency content in the image. Machine learning system 204 may fit a model to the camera response function fₜ(e.g., using parametric curves) to estimate parameters like, but not limited to at. The fitting process may help capture the non-linear relationship between scene brightness and recorded pixel values.

The machine learning system 204 may encode estimated exposure Et into the Tₑₓₚ channel of Tₜ, providing the autonomous driving system 205 with information about the overall brightness of the scene. The machine learning system 204 may encode the estimated focus distance Dfₜ into the T_{focus} channel, informing the autonomous driving system 205 about the level of sharpness in different image regions.

The estimated response function parameters (e.g., at) may be encoded into their respective channels, allowing the autonomous driving system 205 to understand the sensor's response to light and adjust corresponding processing accordingly. The effectiveness of f( ) may depend on the accuracy of its estimation algorithms. Errors in estimation may lead to suboptimal performance of autonomous driving system 205. The estimation process should be computationally efficient to enable real-time updates for video processing.

Machine learning system 204 may empower the autonomous driving system 205 to adjust one or more algorithms based on the changing sensor metadata, leading to more tailored and effective results. At each time step t, a new raw input image It may be captured.

The machine learning system 204 may provide updated Tₜ to the autonomous driving system 205 alongside Iₜ.

In an aspect, one or more of the modules 304-316 may employ CNNs. In such implementations, SIT 206 may provide CNNs with explicit sensor information to enhance their ability to understand and process images or point clouds, accounting for sensor-specific characteristics.

Traditionally, CNNs rely solely on the raw image/point cloud data for learning, which can lead to difficulties in generalizing to new sensors with different metadata. For example, a network trained on images from one camera may perform poorly on images from another camera with different exposure or focus settings. SIT 206 may be concatenated channel-wise with the raw image or point cloud data. The concatenation creates a multi-channel input where each channel represents a different aspect of the sensor or the scene. The multi-channel input may be fed into a CNN. Convolutional layers of CNN may learn to extract features from both the raw data and the sensor metadata channels. A convolution operating on the exposure channel, for example, may learn to: amplify features in underexposed regions to make them more visible, attenuate features in overexposed regions to prevent information loss. Such convolution operation may lead to better performance in tasks affected by lighting variations. By explicitly accounting for sensor characteristics, CNNs may achieve better performance in various tasks, especially under challenging imaging conditions. Modules 304-316 that employ CNN may adjust their corresponding processing based on sensor properties, leading to more tailored and effective results. Modules 304-316 trained with sensor information may generalize better to images from different sensors with similar characteristics.

Adding sensor channels may increase input dimensionality, potentially increasing computational costs. CNN architectures and training strategies may need adjustments to effectively utilize sensor metadata.

Explicit sensor information may allow the autonomous driving system 205 to understand how different sensor settings affect the appearance of the captured data. The autonomous driving system 205 may adjust its processing based on the provided sensor information to extract relevant features and achieve good performance across a wider range of sensors. By providing a common representation of sensor data through SIT 206, the autonomous driving system 205 may become agnostic to the exact sensor used. In other words, the same autonomous driving system 205 may use images or point clouds from different sensors without significant modifications. Sensor agnosticism is particularly beneficial for tasks like object detection, image segmentation, or point cloud registration, where consistent performance across different sensors is important. As a non-limiting example, consider autonomous driving system 205 that is trained to detect cars in images. Without sensor information, the autonomous driving system 205 may misinterpret reflections on wet roads as cars due to the increased brightness caused by water. However, if the autonomous driving system 205 has access to the exposure channel in SIT 206, the autonomous driving system 205 may learn to compensate for the brightness change and correctly identify the reflections as non-car objects. The aforementioned ability to understand and adapt to different sensor characteristics may allow the autonomous driving system 205 to function effectively regardless of the specific camera used to capture the image.

In summary, the machine learning system 204 may represent sensor metadata as a structured tensor, separate from the raw image/point cloud data. Machine learning system 204 may provide this tensor (SIT 206) as explicit input to various modules 304-316 of the autonomous driving system 205, enabling the modules 304-316 to directly access and utilize sensor information. SIT module 207 may encode sensor metadata at the individual pixel level into SIT 206. Furthermore, SIT 206 may offer fine-grained spatial details about sensor properties, allowing the autonomous driving system 205 to account for local variations. In an aspect, SIT 206 may incorporate well-established mathematical models of camera and lens behavior. SIT module 207 may encode model parameters as tensor channels, providing a physics-based understanding of sensor characteristics. In other words, SIT 206 may help autonomous driving system 205 achieve more efficient and accurate learning by explicitly providing sensor context.

SIT 206 may help autonomous driving system 205 adapt to new sensors and imaging conditions more effectively. For example, SIT 206 may store exposure value for each pixel, allowing the autonomous driving system 205 to adjust feature extraction based on local brightness. SIT module 207 may encode focus distance at each pixel, enabling the autonomous driving system 205 to account for depth-dependent blur variations. As yet another non-limiting example, SIT 206 may represent parameters of a lens distortion model, allowing the autonomous driving system 205 to correct for geometric distortions.

Output of the SIT module 207 may be used for image denoising, super-resolution, object detection, segmentation, point cloud registration, 3D reconstruction, and some other tasks that may be performed by autonomous driving system 205. For example, feature fusion module 306 may combine data from multiple sensors with different metadata while accounting for their sensor-specific properties.

SIT 206 may help to develop machine learning system 204 that performs well on data from unseen sensors, not just those used for training. Sensor variations in terms of resolution, noise characteristics, lens properties, etc., may significantly impact performance of the machine learning system 204. SIT 206 may enable wider applicability of models, reducing retraining costs and effort for different devices. Traditional CNNs rely solely on image data, making them sensitive to sensor variations. In contrast, machine learning system 204 described herein should adapt to changes in sensor settings (exposure, focus, etc.) or different camera models. SIT 206 may provide autonomous driving system 205 with per-pixel sensor information. Machine learning system 204 may adapt various modules 304-316 trained on one sensor distribution to work on another. Explicit sensor metadata may induce a prior or inductive bias in the autonomous driving system 205, guiding it towards sensor-aware feature extraction. Explicit sensor metadata may also allow for fine-grained spatial variations in sensor characteristics to be captured (e.g., per-pixel focus). Explicit sensor metadata may act as a complement to data-driven learning, not a replacement. The autonomous driving system 205 may still learn from the raw image data, but the sensor metadata may provide additional context and guidance. Complimenting data-driven learning may lead to faster convergence, improved accuracy, and better generalization compared to purely data-driven techniques.

In an aspect, machine learning system 204 may perform tensor compression using compressor 252. The goal of the tensor compression is to reduce the size of the sensor metadata while retaining information for effective processing. Smaller SIT 206 may require less memory, facilitating storage and transmission. Smaller SIT 206 may be processed faster, reducing computational costs. Compression may remove redundant or noisy information, potentially enhancing performance. Some of the compression techniques that may be used by compressor 252 include PCA and autoencoders. PCA may identify the directions of maximum variance in the data. PCA may project the SIT 206 onto a lower-dimensional subspace that captures most of the variance. Autoencoders are neural networks that may learn a compressed representation of the SIT 206. Autoencoders may capture non-linear relationships and potentially preserve more information than PCA. Dynamic updates may ensure the SIT 206 reflects the most current sensor state, even in dynamic scenarios with auto-adjusting camera settings. Outdated metadata may lead to inaccurate processing and errors. Dynamic updates may be particularly important for real-time applications like video processing. Per-frame updates may recalculate the sensor metadata for each video frame, providing the most up-to-date information. Incremental updates may track changes in camera settings and may update only affected portions of the SIT 206, reducing computational overhead. Compression inevitably involves trade-offs between size and information retention. The challenge is to find the optimal compression level that preserves the most relevant information for the task at hand. Compression and decompression may add computational overhead, which should be considered in real-time applications. Efficient strategies for updating the SIT 206 in real-time may be important for practical sensor-aware processing.

In an aspect, SIT module 207 may encode temporal data into SIT 206. Capturing frame rate and shutter speed may greatly help with motion modeling tasks like action recognition, object tracking, and video stabilization. By understanding the temporal dynamics of sensor data, the autonomous driving system 205 may analyze changes and movements more accurately. Possible channels for encoding temporal data may include, but are not limited to: frame rate, shutter speed, inter-frame time gaps, rolling shutter information (for CMOS sensors), and the like. In an aspect, SIT module 207 may also encode spectral response.

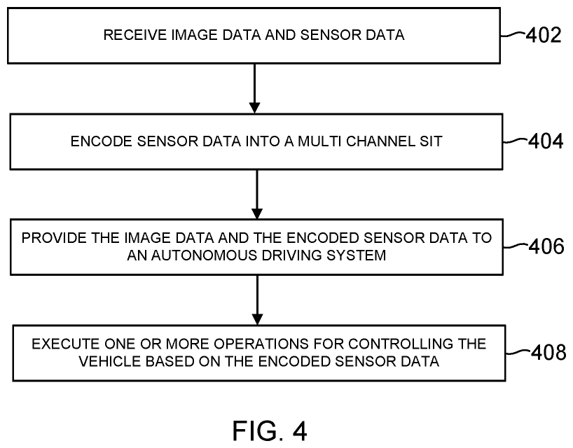

FIG. 4 is a flowchart illustrating an example method for providing sensor metadata using sensor imaging tensor in accordance with the techniques of this disclosure. Although described with respect to computing system 200 (FIG. 2), it should be understood that other devices may be configured to perform a method similar to that of FIG. 4.

In this example, machine learning system 204 may initially receive image data and sensor data from one or more sensor of vehicle 102 (402). Sensor data may include a plurality of characteristics of the one or more sensors 128-134. The machine learning system 204 may encode sensor data into a multichannel SIT 206 (404). The SIT 206 may go beyond simply informing the autonomous driving system 205 about sensor properties. The SIT 206 may potentially help the autonomous driving system 205 to learn more physically-aware and interpretable features. Next, the machine learning system 204 may provide the image data and the encoded sensor data to an autonomous driving system 205 (406). In an aspect, by using the enriched data structure of SIT 206, autonomous driving system 205 may learn how different parameters interact and affect the image formation process without the need for explicitly labeled training data. The autonomous driving system 205 may execute one or more operations for controlling the vehicle 102 based at least in part on the sensor data encoded in SIT 206 (408). For example, knowing the bit depth and pixel size could influence how autonomous driving system 205 performs noise reduction for high-resolution or low-dynamic-range images. Combining data from multiple sensors with SIT 206 may enable even more sophisticated image processing.

The following numbered clauses illustrate one or more aspects of the devices and techniques described in this disclosure.

Clause 1. A method for processing image data and sensor data in an autonomous vehicle, the method comprising: receiving image data and sensor data generated by one or more sensors of an autonomous vehicle; encoding the sensor data into a multichannel sensor imaging tensor to generate encoded sensor data; providing the image data and the encoded sensor data to an autonomous driving system trained to control the autonomous vehicle; and executing, by the autonomous driving system, one or more operations for controlling the autonomous vehicle based at least in part on the image data and the encoded sensor data.

Clause 2. The method of Clause 1, further comprising: compressing the encoded sensor data prior to providing the encoded sensor data to the autonomous driving system to generate compressed encoded sensor data.

Clause 3. The method of Clause 2, wherein compressing the sensor data comprises projecting the encoded sensor data onto a lower-dimensional subspace.

Clause 4. The method of Clause 2, wherein the compressed encoded sensor data comprises compressed Camera Response Function (CRF) data.

Clause 5. The method of any of Clauses 1-4, wherein encoding the sensor data comprises encoding a plurality of distortion coefficients into separate channels within the multichannel sensor imaging tensor.

Clause 6. The method of any of Clauses 1-5, wherein the sensor data comprises spectral response data.

Clause 7. The method of any of Clauses 1-6, wherein the autonomous driving system is trained to infer relationships between the image data and the sensor data.

Clause 8. The method of any of Clauses 1-7, wherein the sensor data comprises at least one of: exposure time data, ISO/gain data, lens aperture data, focal length data, focus distance data, pixel size data and bit depth data.

Clause 9. The method of any of Clauses 1-8, wherein the sensor data comprises video capture data.

Clause 10. An apparatus configured to process image data and sensor data in an autonomous vehicle, the apparatus comprising: a memory; and one or more processors implemented in circuitry and in communication with the memory, the one or more processors configured to: receive image data and sensor data generated by one or more sensors of an autonomous vehicle; encode the sensor data into a multichannel sensor imaging tensor to generate encoded sensor data; provide the image data and the encoded sensor data to an autonomous driving system trained to control the autonomous vehicle; and execute, by the autonomous driving system, one or more operations for controlling the autonomous vehicle based at least in part on the image data and the encoded sensor data.

Clause 11. The apparatus of Clause 10, wherein the one or more processors are further configured to: compress the encoded sensor data prior to providing the encoded sensor data to the autonomous driving system to generate compressed encoded sensor data.

Clause 12. The apparatus of Clause 11, wherein to compress the sensor data, the one or more processors are further configured to: project the encoded sensor data onto a lower-dimensional subspace.

Clause 13. The apparatus of Clause 11, wherein the compressed encoded sensor data comprises compressed Camera Response Function (CRF) data.

Clause 14. The apparatus of any of Clauses 10-13, wherein to encode the sensor data, the one or more processors are further configured to: encode a plurality of distortion coefficients into separate channels within the multichannel sensor imaging tensor.

Clause 15. The apparatus of any of Clauses 10-14, wherein the sensor data comprises spectral response data.

Clause 16. The apparatus of any of Clauses 10-15, wherein the autonomous driving system is trained to infer relationships between the image data and the sensor data.

Clause 17. The apparatus of any of Clauses 10-16, wherein the sensor data comprises at least one of: exposure time data, ISO/gain data, lens aperture data, focal length data, focus distance data, pixel size data and bit depth data.

Clause 18. The apparatus of any of Clauses 10-17, wherein the sensor data comprises video capture data.

Clause 19. A non-transitory computer-readable storage medium storing instructions that, when executed, cause one or more processors of a device configured to process image data and sensor data in an autonomous vehicle to: receive image data and sensor data generated by one or more sensors of an autonomous vehicle; encode the sensor data into a multichannel sensor imaging tensor to generate encoded sensor data; provide the image data and the encoded sensor data to an autonomous driving system trained to control the autonomous vehicle; and execute, by the autonomous driving system, one or more operations for controlling the autonomous vehicle based at least in part on the image data and the encoded sensor data.

Clause 20. The non-transitory computer-readable storage medium of Clause 19, wherein the instructions further cause the one or more processors to: compress the encoded sensor data prior to providing the encoded sensor data to the autonomous driving system to generate compressed encoded sensor data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for processing image data and sensor data in an autonomous vehicle, the method comprising:
receiving image data and sensor data generated by one or more sensors of an autonomous vehicle;
encoding the sensor data into a multichannel sensor imaging tensor to generate encoded sensor data;
providing the image data and the encoded sensor data to an autonomous driving system trained to control the autonomous vehicle; and
executing, by the autonomous driving system, one or more operations for controlling the autonomous vehicle based at least in part on the image data and the encoded sensor data.

2. The method of claim 1, further comprising:
compressing the encoded sensor data prior to providing the encoded sensor data to the autonomous driving system to generate compressed encoded sensor data.

3. The method of claim 2, wherein compressing the sensor data comprises projecting the encoded sensor data onto a lower-dimensional subspace.

4. The method of claim 2, wherein the compressed encoded sensor data comprises compressed Camera Response Function (CRF) data.

5. The method of claim 1, wherein encoding the sensor data comprises encoding a plurality of distortion coefficients into separate channels within the multichannel sensor imaging tensor.

6. The method of claim 1, wherein the sensor data comprises spectral response data.

7. The method of claim 1, wherein the autonomous driving system is trained to infer relationships between the image data and the sensor data.

8. The method of claim 1, wherein the sensor data comprises at least one of: exposure time data, ISO/gain data, lens aperture data, focal length data, focus distance data, pixel size data and bit depth data.

9. The method of claim 1, wherein the sensor data comprises video capture data.

10. An apparatus configured to process image data and sensor data in an autonomous vehicle, the apparatus comprising:
a memory; and
one or more processors implemented in circuitry and in communication with the memory, the one or more processors configured to:
receive image data and sensor data generated by one or more sensors of an autonomous vehicle;
encode the sensor data into a multichannel sensor imaging tensor to generate encoded sensor data;
provide the image data and the encoded sensor data to an autonomous driving system trained to control the autonomous vehicle; and
execute, by the autonomous driving system, one or more operations for controlling the autonomous vehicle based at least in part on the image data and the encoded sensor data.

11. The apparatus of claim 10, wherein the one or more processors are further configured to:
compress the encoded sensor data prior to providing the encoded sensor data to the autonomous driving system to generate compressed encoded sensor data.

12. The apparatus of claim 11, wherein to compress the sensor data, the one or more processors are further configured to:
project the encoded sensor data onto a lower-dimensional subspace.

13. The apparatus of claim 11, wherein the compressed encoded sensor data comprises compressed Camera Response Function (CRF) data.

14. The apparatus of claim 10, wherein to encode the sensor data, the one or more processors are further configured to:
encode a plurality of distortion coefficients into separate channels within the multichannel sensor imaging tensor.

15. The apparatus of claim 10, wherein the sensor data comprises spectral response data.

16. The apparatus of claim 10, wherein the autonomous driving system is trained to infer relationships between the image data and the sensor data.

17. The apparatus of claim 10, wherein the sensor data comprises at least one of: exposure time data, ISO/gain data, lens aperture data, focal length data, focus distance data, pixel size data and bit depth data.

18. The apparatus of claim 10, wherein the sensor data comprises video capture data.

19. A non-transitory computer-readable storage medium storing instructions that, when executed, cause one or more processors of a device configured to process image data and sensor data in an autonomous vehicle to:
receive image data and sensor data generated by one or more sensors of an autonomous vehicle;
encode the sensor data into a multichannel sensor imaging tensor to generate encoded sensor data;
provide the image data and the encoded sensor data to an autonomous driving system trained to control the autonomous vehicle; and
execute, by the autonomous driving system, one or more operations for controlling the autonomous vehicle based at least in part on the image data and the encoded sensor data.

20. The non-transitory computer-readable storage medium of claim 19, wherein the instructions further cause the one or more processors to:
compress the encoded sensor data prior to providing the encoded sensor data to the autonomous driving system to generate compressed encoded sensor data.
